(19) United States
(12) Patent Application Publication
(10) Pub. No.: US 2025/0132517 A1
(43) Pub. Date: Apr. 24, 2025

(54) CONNECTOR

(71) Applicant: SUMITOMO WIRING SYSTEMS, LTD., Mie (JP)

(72) Inventor: Taiga OGURI, Mie (JP)

(21) Appl. No.: 18/908,130

(22) Filed: Oct. 7, 2024

(30) Foreign Application Priority Data
Oct. 19, 2023 (JP) 2023-180018

(51) Int. Cl. H01R 13/506; H01R 13/639; H01R 13/641

(52) U.S. Cl. CPC H01R 13/506; H01R 13/639; H01R 13/641

(57) ABSTRACT

A retainer has insertion portions and that allow a body portion of a terminal fitting to pass therethrough at a temporary locking position, and a detection portion protruding from a wall surface portion that defines the insertion portions and capable of interfering with a first wall of the terminal fitting in a half-inserted state into a housing from a side opposite to a second wall, and is configured to reduce an amount of protrusion from an outer surface of the housing as it goes from the temporary locking position to a full locking position. The detection portion has a recess shaped to move away from protrusions at the temporary locking position, and is disposed corresponding to a middle portion excluding both end portions in a width direction in the wall surface portion.

### CROSS-REFERENCE TO RELATED APPLICATIONS

This application is based on and claims priority from Japanese Patent Application No. 2023-180018, filed on Oct. 19, 2023, with the Japan Patent Office, the disclosure of which is incorporated herein in its entirety by reference.

### TECHNICAL FIELD

The present disclosure relates to a connector.

### BACKGROUND

The connector described in JP 2013-101869A includes a terminal fitting, a housing that houses the terminal fitting, and a retainer that is disposed to be movable relative to the housing between a temporary locking position and a full locking position. A lower surface of the retainer is disposed to protrude from a lower surface of the housing in the temporary locking position and not to protrude from the lower surface of the housing in the full locking position. The terminal fitting has a tubular connecting portion. The connecting portion has a protrusion protruding downward from a lower wall (see FIG. 3 of JP 2013-101869A). Further, the terminal fitting has connecting side walls continuous with rear ends of left and right side walls of the connecting portion (a portion indicated by a reference numeral 24 in FIG. 3).

The retainer has a terminal insertion hole that allows the connecting portion to pass therethrough at the temporary locking position, and a terminal locking portion that is provided to protrude from a bottom surface of the terminal insertion hole and is disposed to be lockable to a rear end of the connecting portion at the full locking position. The terminal locking portion is provided to protrude biasedly from one end portion in a width direction of the bottom surface of the terminal insertion hole to avoid interference with the protrusion at the temporary locking position. When the terminal fitting is not inserted to a correct position (a proper insertion depth) into the housing, the terminal locking portion abuts against a lower surface of the connecting portion, and restricts movement of the retainer from the temporary locking position to the full locking position. At this time, the lower surface of the retainer is in a position protruding downward from the lower surface of the housing, so that it is possible to detect that the terminal fitting is in a state (a half-inserted state) of not being inserted to the correct position in the housing, for example, by visually checking an amount of protrusion of the retainer from the lower surface of the housing. In addition, JP 2013-008516A also describes the connector including the retainer.

### SUMMARY

In JP 2013-101869 A, when the connector is made smaller, the amount of protrusion of the retainer cannot be sufficiently ensured when the terminal locking portion of the retainer interferes with the terminal fitting in the half-inserted state. In contrast, when a protruding dimension of the terminal locking portion of the retainer is increased, the amount of protrusion of the retainer can be increased when the terminal locking portion interferes with the terminal fitting in the half-inserted state. However, when the protruding dimension of the terminal locking portion is large, a problem occurs in that even when the terminal fitting is inserted to a proper depth into the housing, the terminal locking portion of the retainer abuts against the connecting side wall of the terminal fitting, and the retainer cannot reach the full locking position. Here, when the terminal locking portion is provided on a widthwise center side of the bottom surface of the terminal insertion hole, the terminal locking portion can be prevented from abutting against the connecting side wall. However, in this case, a new problem occurs in that when the retainer is in the temporary locking position, the terminal locking portion abuts against the protrusion of the terminal fitting, and the terminal fitting cannot be inserted into the housing.

In view of the above, an object of the present disclosure is to provide a connector capable of detecting the half-inserted state of the terminal fitting from the amount of protrusion of the retainer without interfering with assembly of the retainer and the terminal fitting to the housing.

The present disclosure is a connector including: a housing that houses a terminal fitting; and a retainer that is disposed to be movable relative to the housing between a temporary locking position and a full locking position, in which a body portion of the terminal fitting has a pair of side walls arranged spaced apart in a width direction, a first wall and a second wall arranged to be continuous with the pair of side walls and spaced apart in a height direction, a protrusion protruding from one end portion in a width direction of the first wall to a side opposite to a side where the second wall is located, and a pair of connecting side walls continuous with portions on the second wall side at rear ends of the pair of side walls, the retainer has an insertion portion that allows the body portion to pass therethrough at the temporary locking position, and a detection portion protruding from a wall surface portion that defines the insertion portion and capable of interfering with the first wall of the terminal fitting in a half-inserted state into the housing from a side opposite to the second wall, and is configured to reduce an amount of protrusion from an outer surface of the housing as it goes from the temporary locking position to the full locking position, and the detection portion has a recess shaped to move away from the protrusion at the temporary locking position, and is disposed corresponding to a middle portion excluding both end portions in a width direction in the wall surface portion.

According to the present disclosure, it is possible to provide a connector capable of detecting the half-inserted state of the terminal fitting from the amount of protrusion of the retainer without interfering with the assembly of the retainer and the terminal fitting to the housing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector of a first embodiment.

FIG. 2 is an enlarged cross-sectional view from front of the connector of the first embodiment showing a state in which a body portion of a terminal fitting passes through an insertion portion of a retainer when the retainer is in a temporary locking position relative to a housing.

FIG. 3 is an enlarged side sectional view of the connector of the first embodiment showing a state in which movement of the retainer to a full locking position is restricted when the terminal fitting is in a half-inserted state.

FIG. 4 is an enlarged side sectional view of the connector of the first embodiment showing a state in which the terminal fitting is housed in the housing and the retainer has moved to the full locking position relative to the housing.

FIG. 5 is an enlarged cross-sectional view from rear of the connector of the first embodiment showing a state in which the terminal fitting is housed in the housing and the retainer has moved to the full engagement position relative to the housing.

FIG. 6 is an oblique view of the terminal fitting of the connector of the first embodiment.

FIG. 7 is a front view of the retainer of the connector of the first embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENT OF THE PRESENT DISCLOSURE

First, embodiments of the present disclosure will be listed and described.

(1) A connector of the present disclosure including a housing that houses a terminal fitting; and a retainer that is disposed to be movable relative to the housing between a temporary locking position and a full locking position, in which a body portion of the terminal fitting has a pair of side walls arranged spaced apart in a width direction, a first wall and a second wall arranged to be continuous with the pair of side walls and spaced apart in a height direction, a protrusion protruding from one end portion in a width direction of the first wall to a side opposite to a side where the second wall is located, and a pair of connecting side walls continuous with portions on the second wall side at rear ends of the pair of side walls, the retainer has an insertion portion that allows the body portion to pass therethrough at the temporary locking position, and a detection portion protruding from a wall surface portion that defines the insertion portion and capable of interfering with the first wall of the terminal fitting in a half-inserted state into the housing from a side opposite to the second wall, and is configured to reduce an amount of protrusion from an outer surface of the housing as it goes from the temporary locking position to the full locking position, and the detection portion has a recess shaped to move away from the protrusion at the temporary locking position, and is disposed corresponding to a middle portion excluding both end portions in a width direction in the wall surface portion.

According to a configuration of (1) above, the detection portion is disposed corresponding to the middle portion of the wall surface portion that defines the insertion portion, so that the detection portion can be prevented from abutting against the connecting side wall during a process of the retainer moving toward the full locking position. Further, the recess moves away from the protrusion at the temporary locking position, so that the detection portion can be prevented from abutting against the protrusion. Thus, it is possible to reduce constraints on assembly of the retainer and the terminal fitting to the housing, and an amount of protrusion of the retainer from the outer surface of the housing can also be increased when the terminal fitting is in the half-inserted state (a state of not being inserted to a proper depth into the housing) and the detection portion interferes with the first wall. As a result, reliability of detection when the detection portion detects the half-inserted state of the terminal fitting can be improved.

(2) In the connector according to (1) above, it is preferable that the detection portion has the recess formed by cutting out a corner on one side of corners on both sides in a width direction of a tip portion in a protruding direction from the wall surface portion.

According to a configuration of (2) above, a corner on the other side of the detection portion, where no recess is formed, can be formed into a shape having a predetermined rigidity.

(3) In the connector according to (1) or (2) above, it is preferable that a tip portion in a protruding direction from the wall surface portion of the detection portion is located in an opposing space in a width direction formed between the pair of connecting side walls at the full locking position.

According to a configuration of (3) above, since the detection portion can be formed without any constraints from the connecting side wall, for example, a movement stroke of the retainer moving between the temporary locking position and the full locking position can be increased, and the retainer can be adjusted to a desired amount of protrusion.

(4) In the connector according to any one of (1) to (3) above, it is preferable that the protrusion has a curved outer peripheral portion in a front view, and the recess has a curved surface curved in a front view corresponding to the outer peripheral portion.

According to a configuration of (4) above, when the terminal fitting is in the half-inserted state, since the curved surface of the recess can contact along an outer peripheral surface of the protrusion, it is possible to ensure a sufficient contact area between the detection portion and the protrusion and prevent rattling in the retainer that detects the half-inserted state of the terminal fitting. As a result, the reliability of detection when the detection portion detects the half-inserted state of the terminal fitting can be further improved. In addition, since a widthwise thickness on a base end side of the detection portion can be increased, it is possible to avoid a decrease in rigidity of the detection portion due to the recess.

### Details of Embodiment of the Present Disclosure

Specific examples of the present disclosure will be described below with reference to the drawings. Note that the present invention is not limited to the examples, but is indicated by the scope of the claims, and is intended to include meanings equivalent to the scope of the claims and all changes within the scope of the claims.

### First Embodiment

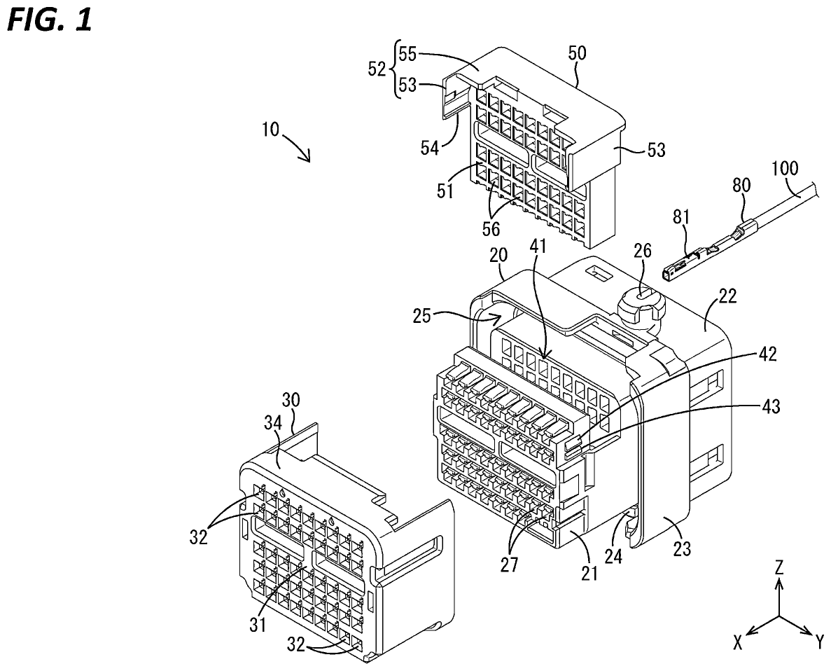

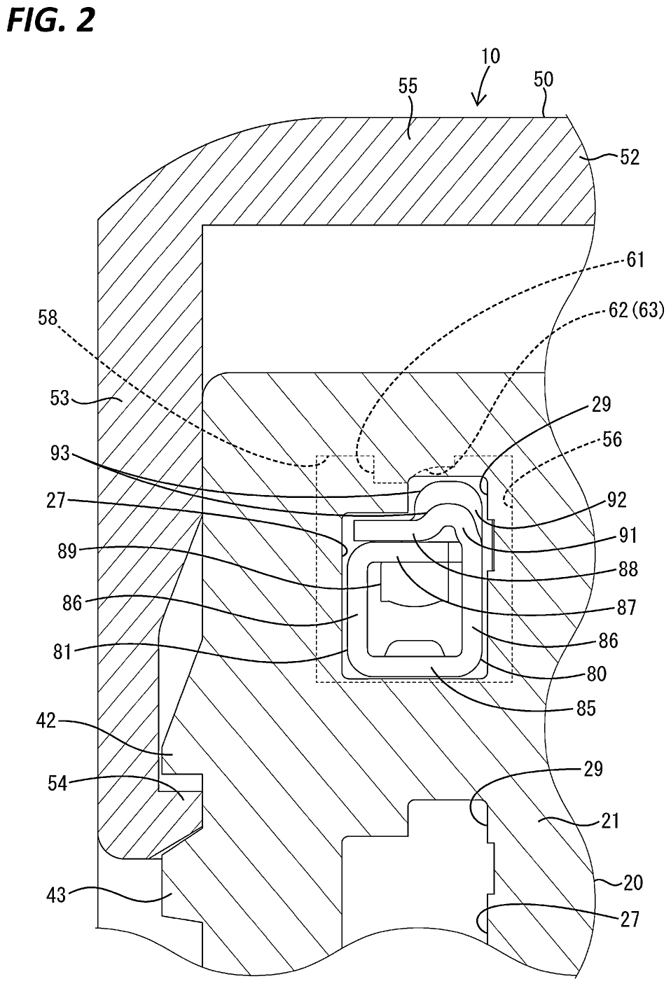

As shown in FIG. 1, a connector 10 of a first embodiment includes a housing 20 capable of housing a terminal fitting 80, and a retainer 50 to be attached to the housing 20. The housing 20 is capable of fitting with a mating connector (not shown). The retainer 50 is movable relative to the housing 20 between the temporary locking position and the full locking position in a direction intersecting a fitting direction of the housing 20 and the mating connector. Note that in the following description, as for a front-rear direction, a side of the housing 20 fitted with the mating connector is referred to as a front side. A left-right direction is synonymous with the width direction, and is based on the left-right direction in FIGS. 1 and 2. An up-down direction is synonymous with the height direction, and is based on the up-down direction in each figure. The retainer 50 moves in the up-down direction between the temporary locking position and the full locking position. The terminal fitting 80 is inserted and removed by moving in the front-rear direction relative to the housing 20. In FIG. 1, the front-rear direction is indicated by an arrow X, the left-right direction is indicated by an arrow Y, and the up-down direction is indicated by an arrow Z. These directional references are for convenience and do not necessarily coincide with directional references when the connector 10 is mounted on a vehicle or the like (not shown).

### (Housing 20)

The housing 20 is made of synthetic resin, and as shown in FIG. 1, has a block-shaped housing body 21, a tubular rubber plug housing portion 22 protruding rearward from an outer peripheral edge portion of a rear surface of the housing body 21, and a fitting tube portion 23 that surrounds the outer periphery of the housing body 21. The fitting tube portion 23 is connected to a boundary portion between the housing body 21 and the rubber plug housing portion 22 via a connecting portion 24 protruding radially. A space between the fitting tube portion 23 and the housing body 21 and in front of the connecting portion 24 is a fitting space 25 that can be fitted with the mating connector.

A one-piece rubber stopper (not shown) is inserted from the rear into the rubber plug housing portion 22 and housed therein. The rubber stopper provides a liquid-tight seal between a covered electric wire 100 connected to the terminal fitting 80 and an inner peripheral surface of the rubber plug housing portion 22. A shaft 26 is formed to protrude from an upper surface and a lower surface of the rubber plug housing portion 22 (the shaft on the lower surface is not shown in FIG. 1). A lever (not shown) is attached to the shaft 26. The lever is a member that rotates around the shaft 26 while engaged with the mating connector, and reduces a fitting force between the housing 20 and the mating connector.

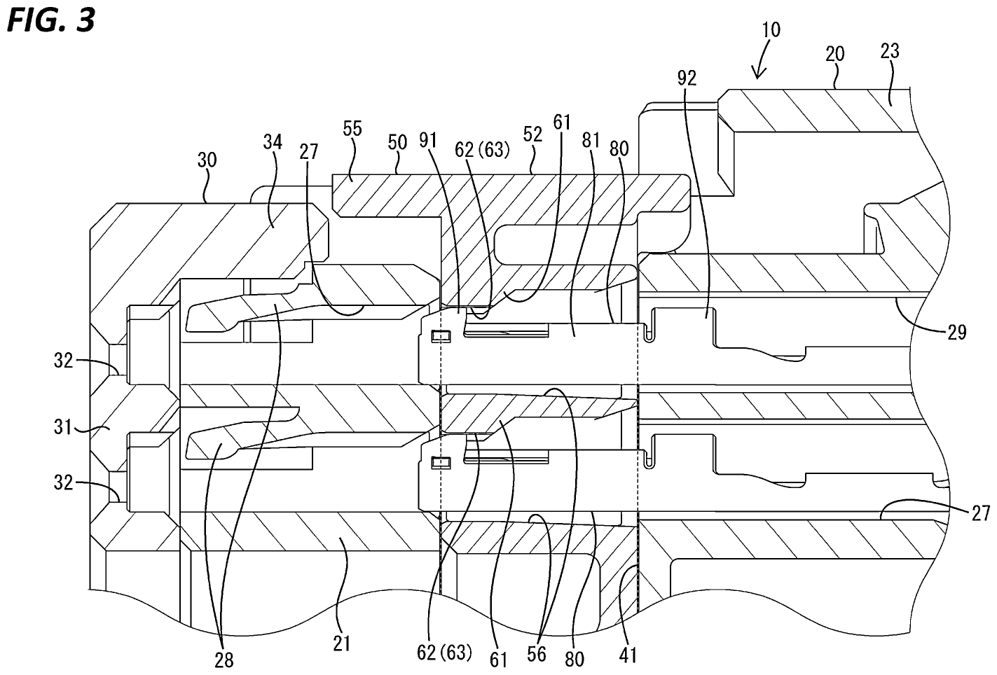

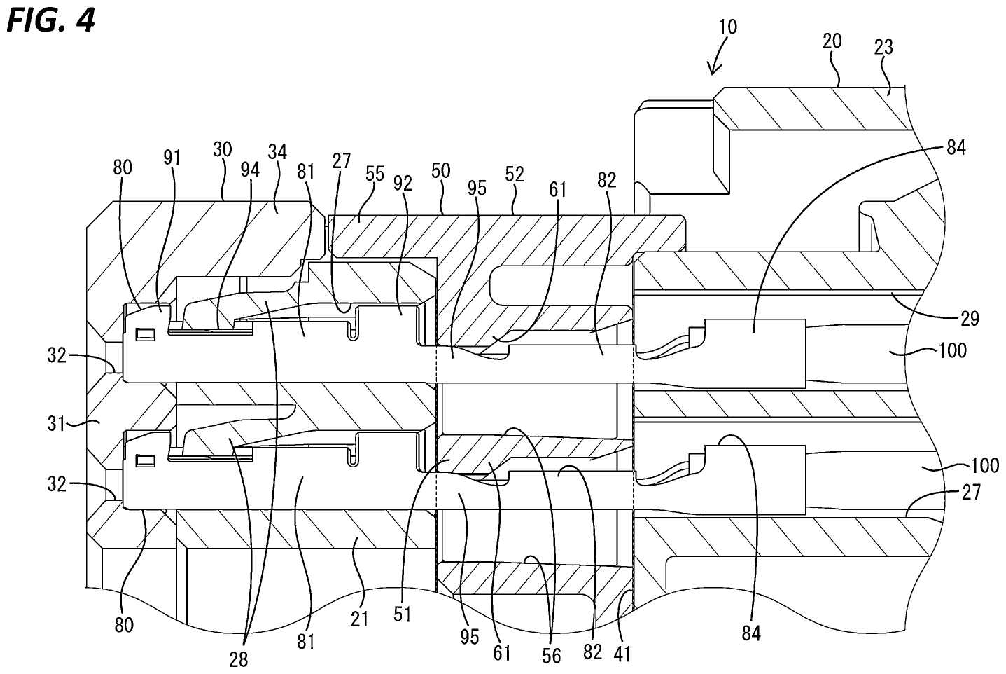

The housing body 21 has a plurality of cavities 27 extending in the front-rear direction. The cavities 27 are arranged in multiple rows in the left-right direction and in multiple stages in the up-down direction in the housing body 21. As shown in FIG. 3, an elastically deformable lance 28 is formed to protrude from an inner upper surface of each cavity 27. The terminal fitting 80 is inserted into each cavity 27 from the rear. As shown in FIG. 4, the terminal fitting 80 is locked with the lance 28 and is primarily prevented from coming out of the cavity 27. As shown in FIG. 2, each cavity 27 is rectangular in a front view. The housing body 21 has a guide groove 29 formed in a shape recessed upward from one corner at an upper right end of each cavity 27. The guide groove 29 extends in the front-rear direction while communicating with the cavity 27 in the housing body 21. Protrusions 91 and 92 to be described later of the terminal fitting 80 are inserted into the guide groove 29.

As shown in FIGS. 1, 3, and 4, a front holder 30 is attached to the housing body 21 from the front. The front holder 30 is made of synthetic resin, is cap-shaped, and has a front wall 31 that covers a front surface of the housing body 21. The front wall 31 is formed with a plurality of tab insertion holes 32 through which tabs of a mating terminal fitting (not shown) can be inserted. Each tab insertion hole 32 is disposed in a position corresponding to each cavity 27.

Further, the housing body 21 has a retainer mounting hole 41 into which the retainer 50 can be inserted. The retainer mounting hole 41 extends in the up-down direction rearward of the lance 28 and opens to an upper surface of the housing body 21 as well as left and right side surfaces of the housing body 21 as shown in FIG. 1. Each cavity 27 is separated and disposed at the front and rear of the housing body 21 via the retainer mounting hole 41. The retainer 50 is inserted into the retainer mounting hole 41 from above. A front end of the fitting tube portion 23 is located rearward of the retainer mounting hole 41 so that interference with the retainer 50 can be avoided during an assembly process.

As shown in FIGS. 1 and 2, the housing body 21 is formed with a first retaining portion 42 and a second retaining portion 43 for retaining the retainer 50 in the temporary locking position and the full locking position. The first retaining portion 42 and the second retaining portion 43 are provided to protrude side by side in the up-down direction and forward of the retainer mounting hole 41 on the left and right side surfaces of the housing body 21. The first retaining portion 42 and the second retaining portion 43 are both rib-shaped and extend in the front-rear direction. The first retaining portion 42 is disposed above the second retaining portion 43. In addition, a seal ring (not shown) is attached to an outer peripheral surface of the housing body 21 to seal between the housing body 21 and the mating connector fitted into the fitting space 25. The seal ring is attached to the outer peripheral surface of the housing body 21 behind the retainer mounting hole 41 and in front of the connecting portion 24.

### (Terminal Fitting 80)

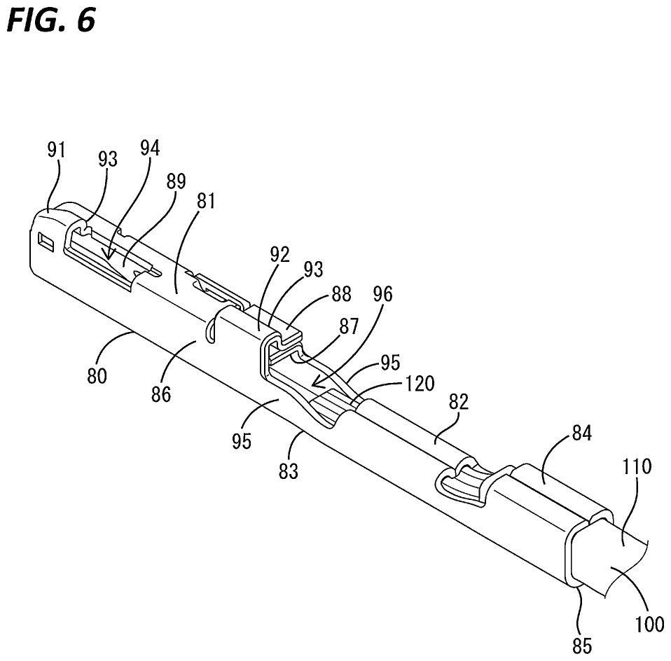

The terminal fitting 80 is formed as a single unit, for example, by bending a conductive metal plate. As shown in FIGS. 1 and 6, the terminal fitting 80 has an elongated shape extending in the front-rear direction. As shown in FIG. 6, the terminal fitting 80 has a tubular body portion 81, a wire barrel portion 82 located behind the body portion 81, a connecting portion 83 located between the wire barrel portion 82 and the body portion 81, and an insulation barrel portion 84 continuous with the rear of the wire barrel portion 82. The terminal fitting 80 also has a second wall 85 that extends over its entire length in the front-rear direction. The body portion 81, the connecting portion 83, the wire barrel portion 82, and the insulation barrel portion 84 are arranged in sequence from the front side on the second wall 85 while including corresponding portions of the second wall 85.

The wire barrel portion 82 is crimped and electrically connected to a conductor 120 exposed by removing an insulating coating 110 at a terminal portion of the covered electric wire 100. The insulation barrel portion 84 is crimped and mechanically connected to the coating 110 of the terminal portion of the covered electric wire 100.

As shown in FIG. 2, the body portion 81 has a front end portion of the second wall 85, a pair of side walls 86 rising from both left and right ends of the second wall 85, an inner wall 87 extending from an upper end of one of the side walls 86 (a left side wall 86 in FIG. 2) toward the other (right side in FIG. 2), and a first wall 88 extending from an upper end of the other of the side walls 86 toward the one (left side in FIG. 2). The side walls 86 are arranged facing each other with a gap in the left-right direction (width direction). The second wall 85 and the inner wall 87 are arranged facing each other with a gap in the up-down direction (height direction). The second wall 85 and the first wall 88 are arranged with a gap in the up-down direction. The first wall 88 is disposed to overlap an upper surface of the inner wall 87.

The inner wall 87 has an elastic contact portion 89 that can elastically deform inside the body portion 81. When the elastic contact portion 89 comes into contact with a tab of the mating terminal fitting (not shown), the terminal fitting 80 is electrically connected to the mating terminal fitting. The first wall 88 has two protrusions 91 and 92 that protrude upward (opposite to the second wall 85) while bending from an end portion on one (right side in FIG. 2) of left and right sides. As shown in FIG. 6, the protrusions 91 and 92 are arranged at an interval between a front end portion and a rear end portion of the first wall 88. Outer surfaces of the protrusions 91 and 92 have outer peripheral portions 93 curved in a front view. The protrusion 91 on the front side has a tapered shape that narrows toward the front. A rear end of the protrusion 92 on the rear side is disposed at the same position as a rear end of the inner wall 87 in the front-rear direction.

The protrusions 91 and 92 are so-called stabilizers and are arranged at positions corresponding to each guide groove 29 of the housing body 21, as shown in FIG. 2. During a process of inserting the terminal fitting 80 into the cavity 27, the protrusions 91 and 92 are inserted into each guide groove 29, to guide insertion of the terminal fitting 80. When the terminal fitting 80 is attempted to be inserted in an incorrect orientation, such as upside down, relative to the cavity 27, the protrusion 91 on the front side will interfere with the rear surface of the housing body 21, so that erroneous insertion of the terminal fitting 80 into the cavity 27 can be prevented.

As shown in FIG. 6, a lance hole 94 extends through the first wall 88 in a thickness direction. The lance hole 94 is disposed between the protrusions 91 and 92 in the front-rear direction. A portion of the elastic contact portion 89 is visible through the lance hole 94. As shown in FIG. 4, a protruding portion of the lance 28 fits into and is lockable in the lance hole 94.

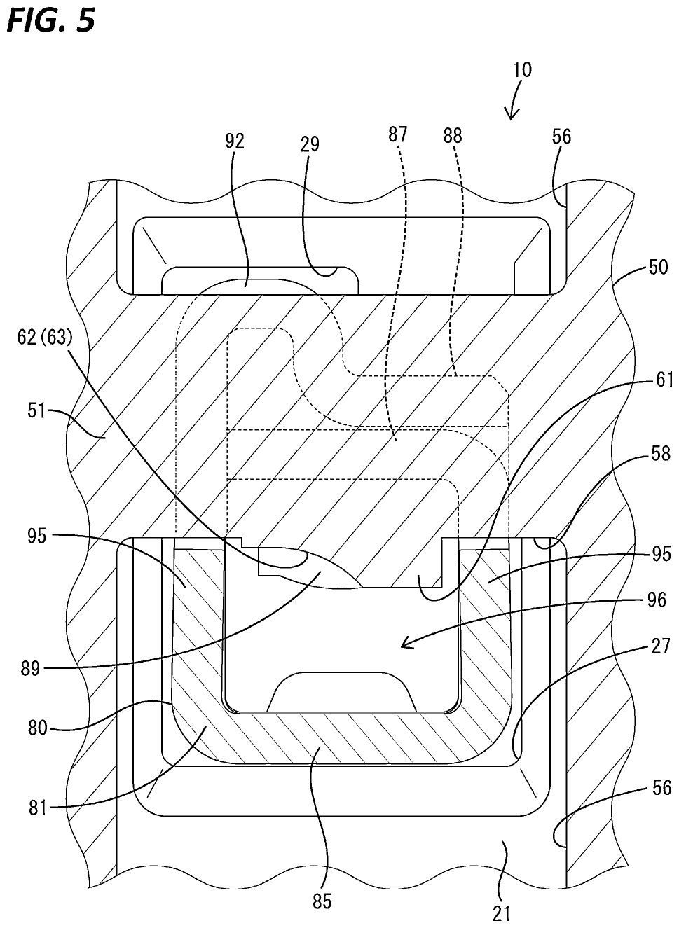

As shown in FIG. 6, the connecting portion 83 has a pair of connecting side walls 95 rising from both the left and right ends of the second wall 85. A front end of each connecting side wall 95 is integrally connected to a lower portion of a rear end of each side wall 86 (a portion on the second wall 85 side). The rear end of each connecting side wall 95 is integrally connected to a rising end portion of the wire barrel portion 82. A tip portion of the conductor 120 crimped to the wire barrel portion 82 is housed inside the connecting portion 83. The connecting side walls 95 are arranged to cover the tip portion of the conductor 120 from both the left and right sides. As shown in FIG. 5, a detection portion 61 to be described later of the retainer 50 can enter an opposing space 96 in which the connecting side walls 95 face each other in the left-right direction.

### (Retainer 50)

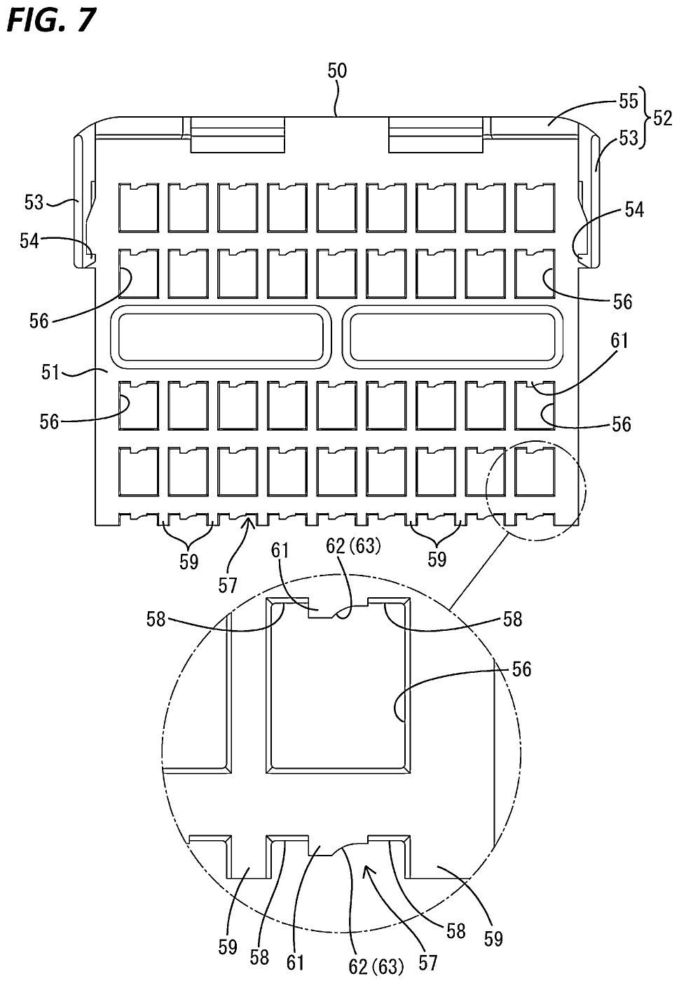

The retainer 50 is made of synthetic resin, and as shown in FIGS. 1 and 7, has a retainer body 51 that is rectangular and lattice-shaped in a front view, and plate-shaped retainer end portions 52 continuous with an upper surface and left and right side surfaces of the retainer body 51 and protruding on both front and rear sides. As shown in FIG. 4, the retainer end portions 52 are arranged to cover opening edge portions on both front and rear sides of the retainer mounting hole 41 on the outer surface (the upper surface and the left and right side surfaces) of the housing body 21. As shown in FIGS. 1 and 7, the retainer end portions 52 have a pair of side plate portions 53 that face each other with a gap in the left and right direction. A retained portion 54 is formed to protrude from each of inner surfaces (mutual facing surfaces) of the side plate portions 53. The retained portion 54 is formed to extend in the front-rear direction at a lower end of the side plate portion 53. The side plate portions 53 are arranged to cover the left and right side surfaces of the housing body 21. As shown in FIG. 2, since the retained portion 54 is sandwiched between the first retaining portion 42 and the second retaining portion 43, the retainer 50 is held in the temporary locking position relative to the housing 20 with its movement in the up-down direction restricted. Further, since the retained portion 54 is disposed to be lockable to the second retaining portion 43 from below, the retainer 50 is held in the full locking position relative to the housing 20 with its upward movement restricted.

An upper wall 55 of the retainer end portion 52 is disposed far above the upper surface of the housing body 21 in the temporary locking position (see FIG. 2), and is disposed to gradually approach the upper surface of the housing body 21 as it moves from the temporary locking position to the full locking position (see FIGS. 3 and 4). As shown in FIG. 4, the upper wall 55 of the retainer end portion 52 is disposed, in the full locking position, within a thickness range of an upper wall portion 34 of the front holder 30 disposed forward, in the up-down direction, and an upper surface of the upper wall 55 is lower than an upper surface of the upper wall portion 34 of the front holder 30. In short, the retainer 50 is configured so that an amount of protrusion from the upper surface of the housing body 21 decreases as it moves from the temporary locking position to the full locking position.

As shown in FIGS. 2 and 7, the retainer 50 has a plurality of insertion portions 56 and 57 through which the body portion 81 of the terminal fitting 80 can be inserted in the temporary locking position. The insertion portions 56 and 57 are respectively arranged to correspond to the cavities 27 of the housing body 21. In the case of the first embodiment, the insertion portions 56 and 57 include an insertion hole 56 and an insertion space 57. A plurality of the insertion holes 56 extend through the retainer body 51 in the front-rear direction. Each insertion hole 56 is rectangular in a front view except for the detection portion 61 described below. A plurality of the insertion spaces 57 are formed in a shape open downward between comb tooth portions 59 at a lower end portion of the retainer body 51. The insertion spaces 57 respectively correspond to the cavities 27 in the lowest row.

The retainer 50 also has a plurality of the detection portions 61 capable of detecting inserted states of terminal fittings 80 into the cavities 27. The detection portions 61 protrudes from wall surface portions 58 (an inner upper surface portion of an inner surface of each insertion hole 56 that faces downward at the upper side, and a lower surface portion of each insertion space 57 that faces downward between the comb tooth portions 59) that define the insertion portions 56 and 57. The wall surface portion 58 includes an inner upper surface that defines the insertion hole 56, and a lower surface of the retainer body 51 that defines the insertion space 57.

As shown in FIG. 7, the detection portion 61 is provided to protrude from a portion (middle portion) of the inner upper surface of the insertion hole 56 excluding both left and right end portions. Specifically, the detection portion 61 is provided to protrude from a portion (central portion) of the inner upper surface of the insertion hole 56 including a center in the left-right direction. Similarly, the detection portion 61 is provided to protrude from a middle portion between adjacent comb tooth portions 59 on the lower surface of the retainer body 51, specifically from a central portion. As shown in FIGS. 3 and 4, the detection portion 61 is formed at a front end portion of the retainer body 51. A rear surface of the detection portion 61 is inclined rearward.

As shown in FIG. 7, the detection portion 61 has a recess 62 formed by cutting out a corner on one side (right side in FIG. 7) of corners on both the left and right sides at the tip portion in the protruding direction from the wall surface portion 58. The recess 62 has a downwardly curved surface 63 curved in a front view. A curved shape of the curved surface 63 corresponds to a curved shape of the outer peripheral portions 93 of the protrusions 91 and 92. A lower end of the curved surface 63 is continuous with a lower end surface (a tip surface in the protruding direction) of the detection portion 61 at a center of the detection portion 61 in the left-right direction or on the other side (left side in FIG. 7) of the center. An upper end of the curved surface 63 is continuous with one side surface (right side surface in FIG. 7) of the detection portion 61 at a center in the height direction of the detection portion 61 or above the center. A base end portion of the detection portion 61 in the protruding direction is provided to protrude from the wall surface portion 58 with a certain width in the left-right direction between the one side surface and the other side surface (left side surface in FIG. 7) of the detection portion 61. A corner 65 on the other side of the detection portion 61 is formed at a portion where the other side surface of the detection portion 61 and the lower end surface of the detection portion 61 intersect perpendicularly. In the case of the first embodiment, the center in the left-right direction of the detection portion 61 and the center in the left-right direction of the wall surface portion 58 are formed at the same position in the left-right direction.

### (Operation of Connector 10)

With the retainer 50 held in the temporary locking position relative to the housing 20, the terminal fitting 80 is inserted into the cavity 27 of the housing body 21 from the rear. As shown in FIG. 2, in the temporary locking position, each detection portion 61 is disposed away from an insertion passage (a portion corresponding to the cavity 27) of the terminal fitting 80. The recess 62 of the detection portion 61 is disposed away from a portion corresponding to the guide groove 29, above and to the other side (left side in FIG. 2) of the left and right sides. That is, the recess 62 of the detection portion 61 is disposed away from the protrusions 91 and 92 inserted into the guide groove 29 in the temporary locking position. Therefore, the terminal fitting 80 is inserted into the cavity 27 without interfering with the retainer 50. When the terminal fitting 80 is inserted to a proper insertion depth into the cavity 27, as shown in FIG. 4, a front end of the body portion 81 abuts against the front wall 31, and further forward movement is restricted. In addition, the protruding portion of the lance 28 fits into the lance hole 94 and is disposed to be lockable to the protrusion 91 on the front side. Thus, the terminal fitting 80 is held in a state of being primarily prevented from coming out of the cavity 27.

The retainer 50 is moved from the temporary locking position toward the full locking position relative to the housing 20. At this time, the retainer end portion 52 is pressed from above. Then, locking between the retained portion 54 and the second retaining portion 43 is released, and the retainer 50 is in a state of being movable to the full locking position.

If the terminal fitting 80 is not inserted to a proper depth into the cavity 27 and remains in a half-inserted position before a proper insertion position as shown in FIG. 3, the detection portion 61 will interfere with the first wall 88 from above (opposite side to the second wall 85) during a movement process (a pushing process) of the retainer 50, and movement of the retainer 50 to the full locking position is restricted. For example, the curved surface 63 of the recess 62 of the detection portion 61 contacts along the outer peripheral portion 93 of the protrusion 91 on the front side, and the movement of the retainer 50 to the full locking position is restricted.

When the terminal fitting 80 is in the half-inserted state, the upper surface of the retainer end portion 52 is located above the upper surface of the housing body 21 and the upper surface of the upper wall portion 34 of the front holder 30. Therefore, it is possible to, for example, visually confirm that the retainer end portion 52 protrudes from the outer surface of the housing 20 and is in a floating state. And by confirming that the retainer 50 is in a floating state, it is possible to detect that the terminal fitting 80 is in the half-inserted state.

When all of the terminal fittings 80 are inserted to the proper depth into the cavities 27, the retainer 50 can reach the full locking position relative to the housing 20. In the full locking position, a front surface of the retainer body 51 is disposed to be lockable to the rear end of the first wall 88 (including the protrusion 92 on the rear side) of the body portion 81. Thus, the terminal fitting 80 is held in a state of being secondarily prevented from coming out of the cavity 27.

When the retainer 50 is in the full locking position relative to the housing 20, as shown in FIG. 5, the wall surface portions 58 of the insertion portions 56 and 57 are arranged close to upper ends of the connecting side walls 95 in the full locking position, and the detection portion 61 is disposed to enter the opposing space 96 of each connecting side wall 95. The front surface of the retainer body 51 is also lockable to rear ends of the inner wall 87 and upper end portions of the side walls 86, in addition to the rear end of the first wall 88. Further, the detection portion 61 can be prevented from interfering with the protrusions 91 and 92 and the connecting side walls 95, and the protruding dimension of the detection portion 61 from the wall surface portion 58 can be increased. Therefore, an amount of protrusion of the retainer end portion 52 protruding from the housing body 21 can also be ensured to be large when the terminal fitting 80 is in the half-inserted state.

As described above, the connector 10 of the first embodiment includes the housing 20 that houses the terminal fitting 80, and the retainer 50 that is disposed to be movable relative to the housing 20 between the temporary locking position and the full locking position. The terminal fitting 80 has the pair of side walls 86 spaced apart in the left-right direction, the first wall 88 and the second wall 85 arranged to be continuous with the side walls 86 and spaced apart in the up-down direction, the protrusions 91 and 92 that protrude from the end portion on the one of the left and right sides of the first wall 88 to the side opposite to the side where the second wall 85 is located, and the pair of connecting side walls 95 continuous with portions on the second wall 85 side at the rear ends of the side walls 86. The retainer 50 has the insertion portions 56 and 57 that allow the body portion 81 to pass therethrough in the temporary locking position, and the detection portion 61 protruding from the wall surface portion 58 that defines the insertion portions 56 and 57 and can interfere with the first wall 88 of the terminal fitting 80 that is in the half-inserted state relative to the housing 20 from the side opposite to the second wall 85, and the amount of protrusion from the outer surface of the housing 20 decreases as it moves from the temporary locking position to the full locking position. Then, the detection portion 61 has the recess 62 that is shaped to move away from the protrusions 91 and 92 in the temporary locking position, and is disposed corresponding to the middle portion excluding end portions on both the left and right sides in the wall surface portion 58.

According to the above configuration, the detection portion 61 is disposed corresponding to the middle portion in the left-right direction of the wall surface portion 58 that defines the insertion portions 56 and 57, so that the detection portion 61 can be prevented from abutting against the connecting side wall 95 during a process of the retainer 50 moving toward the full locking position. Further, the recess 62 moves away from the protrusions 91 and 92 at the temporary locking position, so that the detection portion 61 can be prevented from abutting against the protrusions 91 and 92. Thus, the constraints on the assembly of the retainer 50 and the terminal fitting 80 to the housing 20 can be reduced, and the amount of protrusion of the retainer 50 from the outer surface of the housing 20 can also be increased when the terminal fitting 80 is in the half-inserted state (the state of not being inserted to the proper depth into the housing 20) and the detection portion 61 interferes with the first wall 88. As a result, the reliability of detection when detecting the half-inserted state of the terminal fitting 80 can be further improved.

Further, in the case of the first embodiment, the detection portion 61 has the recess 62 formed by cutting out the corner on the one side (right side in FIG. 2) of the corners on both the left and right sides at the tip portion in the protruding direction from the wall surface portion 58. With this configuration, the corner 65 on the other side of the detection portion 61, where the recess 62 is not formed, can be formed into a shape having a predetermined rigidity.

Further, in the case of the first embodiment, the tip portion in the protruding direction from the wall surface portion 58 of the detection portion 61 is located in the opposing space 96 formed between the connecting side walls 95 in the full locking position. With this configuration, since the detection portion 61 can be formed without being restricted at all by the connecting side walls 95, for example, the movement stroke of the retainer 50 moving between the temporary locking position and the full locking position can be increased, and the retainer 50 can be adjusted to the desired amount of protrusion.

Furthermore, in the case of the first embodiment, the protrusions 91 and 92 have a curved outer peripheral portion 93 in a front view, and the recess 62 has the curved surface 63 curved in a front view corresponding to the outer peripheral portions 93 of the protrusions 91 and 92. With this configuration, when the terminal fitting 80 is in the half-inserted state, the curved surface 63 of the recess 62 can contact along outer peripheral surfaces of the protrusions 91 and 92, so that it is possible to ensure a sufficient contact area between the detection portion 61 and the protrusions 91 and 92 and prevent rattling in the retainer 50 that detects the half-inserted state of the terminal fitting 80. As a result, the reliability of detection when detecting the half-inserted state of the terminal fitting 80 can be further improved. In addition, since a thickness in the left-right direction on the base end side of the detection portion 61 can be increased, it is possible to avoid the decrease in the rigidity of the detection portion 61 due to the recess 62.

### Other Embodiments of the Present Disclosure

The first embodiment disclosed herein should be considered as illustrative in all respects and not restrictive.

In the first embodiment, the upper surface of the retainer end portion 52 is located above the upper surface of the housing body 21 in the full locking position. In contrast, according to other embodiments, the upper surface of the retainer end portion may be disposed continuously with no step to the upper surface of the housing body in the full locking position.

In the first embodiment, the recess 62 is formed by the curved surface 63 curved in a front view. In contrast, according to other embodiments, the recess may include, for example, a linear surface that is inclined in the left-right direction in addition to the curved surface curved in a front view. Further, for example, when the outer peripheral surface of the protrusion is not curved, the recess may be formed only by the linear surface in a front view.

In the first embodiment, an upper wall portion of the body portion 81 has a double-wall structure of the inner wall 87 and the first wall 88. In contrast, according to other embodiments, the upper wall portion of the body portion may be formed only by the first wall without including the inner wall.

In the first embodiment, the two protrusions 91 and 92 are provided on the first wall 88 of the body portion 81 with a gap in the front-rear direction. In contrast, according to other embodiments, only one protrusion may be provided on the body portion, or three or more protrusions may be provided on the body portion.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a housing that houses a terminal fitting; and
a retainer that is disposed to be movable relative to the housing between a temporary locking position and a full locking position, wherein
a body portion of the terminal fitting has a pair of side walls arranged spaced apart in a width direction, a first wall and a second wall arranged to be continuous with the pair of side walls and spaced apart in a height direction, a protrusion protruding from one end portion in a width direction of the first wall to a side opposite to a side where the second wall is located, and a pair of connecting side walls continuous with portions on the second wall side at rear ends of the pair of side walls,
the retainer has an insertion portion that allows the body portion to pass through the insertion portion at the temporary locking position, and a detection portion protruding from a wall surface portion that defines the insertion portion and capable of interfering with the first wall of the terminal fitting in a half-inserted state into the housing from a side opposite to the second wall, and is configured to reduce an amount of protrusion from an outer surface of the housing as it goes from the temporary locking position to the full locking position, and
the detection portion has a recess shaped to move away from the protrusion at the temporary locking position, and is disposed corresponding to a middle portion excluding both end portions in a width direction in the wall surface portion.

2. The connector according to claim 1, wherein the detection portion has the recess formed by cutting out a corner on one side of corners on both sides in a width direction of a tip portion in a protruding direction from the wall surface portion.

3. The connector according to claim 1, wherein a tip portion in a protruding direction from the wall surface portion of the detection portion is located in an opposing space in a width direction formed between the pair of connecting side walls at the full locking position.

4. The connector according to claim 1, wherein
the protrusion has a curved outer peripheral portion in a front view, and
the recess has a curved surface curved in a front view corresponding to the outer peripheral portion.
